(19) United States
(12) Patent Application Publication
(10) Pub. No.: US 2005/0039314 A1
(43) Pub. Date: Feb. 24, 2005

(54) Forming process for stamped workpieces

(76) Inventors: Robert G. Dickie, Newmarket (CA); Bruce Giletman, Toronto (CA)

Correspondence Address: Robert G. Dickie;c/o Spark Innovations Inc., P.O. Box 520, King City, ON, L7B 1A7, CA

(21) Appl. No.: 10/644,811

(22) Filed: Aug. 21, 2003

(51) Int. Cl. B23P 17/00

(52) U.S. Cl. 29/412; 29/418

(57) ABSTRACT

Disclosed herein is a method of making a stamped workpiece from a base material sheet. The base material sheet has a thickness and defines a first plane. The stamped workpiece, upon completion of the process, has a protrusion and a crease line substantially adjacent thereto. The crease line divides the stamped workpiece into a first section and a second section. The method comprises a number of steps. One step in this method is the provision of at least one protrusion in the base material sheet. A workpiece periphery is defined in the base material sheet, the periphery bounding an area of the base material sheet. The area has a first section and a second section. The workpiece periphery adjacent to the first section is substantially separated from the remainder of the base material sheet. The first section is bent away from the first plane along a crease line. The thickness of the base material sheet along the crease line is then substantially reduced. The workpiece is detached from the base material sheet along the workpiece periphery. Optionally, the workpiece may be a tab opener for a food or beverage can.

### FIELD OF THE INVENTION

This invention relates to a stamped workpiece forming process, and more particularly to a stamped workpiece forming process for forming crease lines adjacent to protrusions. One application of this process is in the formation of an improved tab opener for cans. The tab opener has a predefined crease line adjacent to a protrusion in order to allow the user to easily lift the tab opener.

### BACKGROUND OF THE INVENTION

Hundreds of millions of food and beverage can containers are manufactured and sold every year around the world. They are generally made of aluminum, but they may also be made of metals or plastics. Beverage can containers are generally opened with an integrated pull-tab which is riveted to the top of the can. The pull-tab is lifted at one end and pushes against a frangible push-in closure at the top of the can.

U.S. patent application Ser. No. 10/330,476 by the present inventors describes a number of embodiments of a new articulated tab opener for a food and beverage container. The tab includes at least one protrusion extending upwardly from the main webbing of the tab adjacent to a crease line. To open the can, the tab is first pulled upwardly with relative ease until the protrusion abuts either the webbing or an opposing protrusion. Then, the handle acts as a lever, with the rivet as the pivot point, allowing the can to be easily opened with minimal effort.

The improved tab opener has many advantages over previous tab openers. The ease of lifting the end of the tab opener helps to prevent fingernail damage. The ease of lifting is also useful for children and the elderly who may have difficulty lifting the tabs. In addition, can manufacturers have been reducing the size of the can top relative to the overall can diameter thus reducing the clearance between the edge of the tab opener and the periphery of the can top. The reduced clearance makes it more difficult for any user to put their fingernail or fingertip underneath the tab opener to apply leverage. As a result, an easy lift tab opener becomes an even more desirable feature for consumers.

The many advantages of the new tab will not be realized, however, unless a method of forming the tab is devised. The individual features of the tab can be formed by using conventional progressive die techniques. Generally speaking, tabs openers are formed by feeding strips of aluminum wide enough to accommodate three tabs in parallel through a series of stamping or cutting operations until the tab is ready to be riveted onto aluminum can tops. While the improved tab design can be manufactured using a known process, it is difficult to form the crease line between the protrusions. Because the protrusions are positioned quite close to one another and extend significantly above the tab opener's upper surface, a very fine stamping element would be required to form the crease line between the protrusions. A very slight misalignment may result in damage to the protrusion, which may adversely impact the usefulness of the design. In addition, the creasing element may not have sufficient endurance to withstand the hundreds of thousands of stamping operations required by standard tab-forming processes.

The difficulty in using very fine or small tool elements to form cuts and creases between protrusions is not limited to aluminum tabs for cans. A wide variety of other stamped workpieces (e.g. various automobile parts) may need to use a fine tool element to form a crease line adjacent to or between protrusions.

Therefore there is a need for an improved process for performing creasing operations on stamped workpieces, and especially in tabs for metal cans.

### SUMMARY OF THE INVENTION

Disclosed herein is a method of making a stamped workpiece from a base material sheet. The base material sheet has a thickness and defines a first plane. The stamped workpiece, upon completion of the process, has a protrusion and a crease line substantially adjacent thereto. The crease line divides the stamped workpiece into a first section and a second section. The method comprises a number of steps. One step in this method is the provision of at least one protrusion in the base material sheet. A workpiece periphery is defined in the base material sheet, the periphery bounding an area of the base material sheet. The area has a first section and a second section. The workpiece periphery adjacent to the first section is substantially separated from the remainder of the base material sheet. The first section is bent away from the first plane along a crease line. The thickness of the base material sheet along the crease line is then substantially reduced. The workpiece is detached from the base material sheet along the workpiece periphery.

In another aspect of the present invention, the at least one protrusion comprises a first protrusion and a second protrusion. In a further aspect. the first protrusion is opposed to the second protrusion. Optionally, the first protrusion is positioned within the first section and the second protrusion is positioned within the second section.

In a variation of the present invention, the first protrusion and the second protrusion are each provided with an abutment face. In addition, the first and second protrusions are positioned such that the abutment faces are opposed one to the other.

In yet another aspect of the present invention, the method also includes the additional step of bending the first section back towards the first plane, such that the first section lies substantially coplanar with the second section.

In another embodiment of the present invention, there is further described herein a method for forming pull tabs for containers from a base material sheet. The base material sheet has a thickness and defines a first plane. The pull tab has a protrusion and a crease line substantially adjacent thereto. The crease line divides the stamped pull tab into a first section and a second section. The method comprises a number of steps. One step in this method is the provision of at least one protrusion in the base material sheet. A tab periphery is defined in the base material sheet, the tab periphery bounding an area of the base material sheet. The area has a first section and a second section. The tab periphery adjacent to the first section is substantially separated from the remainder of the base material sheet. The first section is bent away from the first plane along a crease line. The thickness of the base material sheet along the crease line is then substantially reduced. Optionally, the workpiece is detached from the base material sheet along the workpiece periphery.

In another aspect of the present invention, the at least one protrusion comprises a first protrusion and a second protrusion. In a further aspect. the first protrusion is opposed to the second protrusion. Optionally, the first protrusion is positioned within the first section and the second protrusion is positioned within the second section.

In a variation of the present invention, the first protrusion and the second protrusion are each provided with an abutment face. In addition, the first and second protrusions are positioned such that the abutment faces are opposed one to the other.

In yet another aspect of the present invention, the method also includes the additional step of bending the first section back towards the first plane, such that the first section lies substantially coplanar with the second section.

In a yet further aspect, the first section is bent downwardly sufficiently to cause material deformation along the crease line. Optionally, the base material sheet is an elongated strip.

In addition, the steps of the method may be performed concurrently in a progressive die for sequential pull-tabs.

The strip may have a width sufficient to accommodate the formation of at least two pull tabs positioned parallel to one another. In such a variation, each of the steps may be performed concurrently for each of the at least two pull tabs positioned parallel to one another.

The method may further comprise the step of detaching the pull tab from the base material sheet along the tab periphery.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a perspective view of a pull-tab to which this invention relates;

FIG. 2 is a perspective view of a strip showing the progressive cutting and stamping steps in sequential positions related to forming the pull-tab of FIG. 1 in accordance with the present invention;

FIG. 3 is an enlarged top view of the first three positions of the metal strip of FIG. 2;

FIG. 4 is an enlarged top view of the fourth to sixth positions of the metal strip of FIG. 2;

FIG. 5 is an enlarged top view of the seventh to ninth positions of the metal strip of FIG. 2;

FIG. 6 is an enlarged top view of the tenth to twelfth positions of the metal strip of FIG. 2;

FIG. 7 is a side view of the tenth to twelfth positions of the metal strip of FIG. 2; and

FIG. 8 is a schematic side view showing the actions of the progressive die during the tenth to twelfth positions.

### DETAILED DESCRIPTION

The novel features which are believed to be characteristic of the present invention, as to its structure, organization, use and method of operation, together with further objectives and advantages thereof, will be better understood from the following discussion.

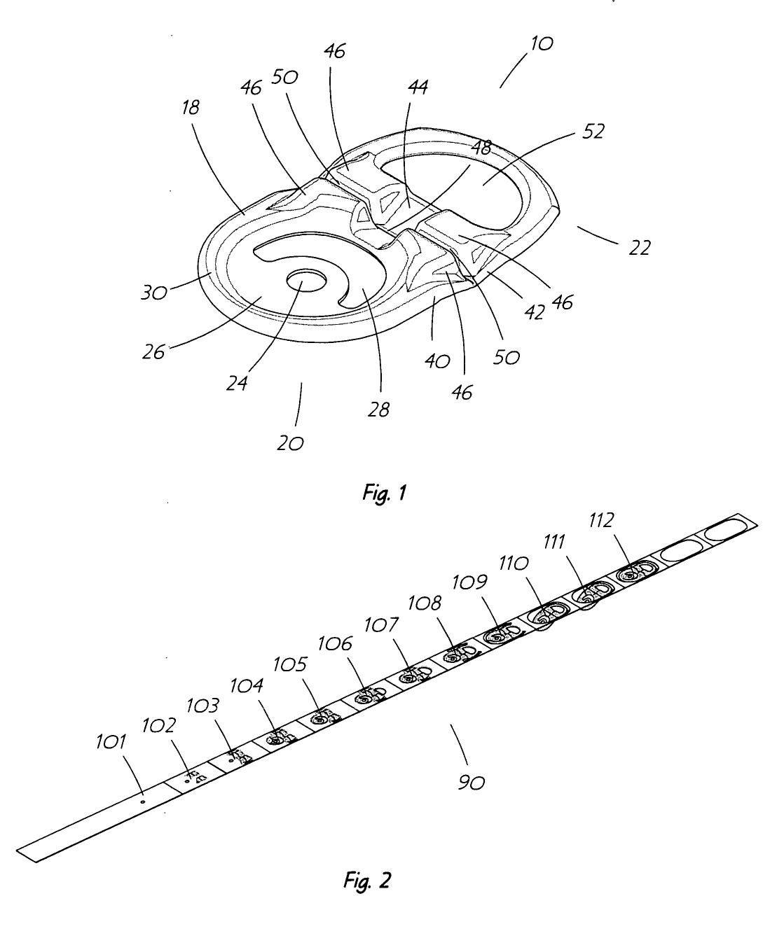

FIG. 1 shows a tab opener 10 for a can having features which enable easy opening of the can. Tab opener 10 has a top webbing or surface 18, a front nose portion 20 and a rear tail portion 22. A rivet aperture 24 is made in a depressed portion or rivet island 26 located near nose portion 20. Rivet hole 24 is adapted to receive a rivet for attachment to a top of a can. Rivet island 26 is defined by a curvilinear aperture 28 along its rear portion and a gently sloping rivet island wall 30 along its front portion. Rivet island wall 30 leads up to the webbing near the front tip of nose portion 20.

The tail portion 20 is articulable. It comprises a front lever portion 40 and a rear lever portion 42. Front lever portion 40 lies in the same plane, and is an extension of, nose portion 20 of tab opener 10.

The tail portion comprises a base portion 44 and at least one pair of protrusions 46 which are upstanding therefrom. Typically there are four protrusions 46 arranged in pairs on either side of a crease line 48, as shown in FIG. 1. However, other arrangements of protrusions are possible as is shown in U.S. patent application Ser. No. 10/330,476.

Each of protrusions 46 has an abutment or front face 50 which is subtended by and extends upwardly from crease line 48. In the arrangement shown in FIG. 1, the front faces 50 of opposed pairs of protrusions 46 are opposed to one another in close proximity. Typically, the angle which is formed between opposed front faces 50 is in the range of 10° and 50°.

Front lever portion 40 and nose portion 20 comprise a first section of tab opener 10, while rear lever portion 42 comprise a second section, where the first and second sections are divided by crease line 48.

A semi-circular finger hole 52 is located centrally in rear lever portion 42, rearwardly of protrusions 46.

Tab opener 10 will now be described in more detail by describing the process for forming tab opener 10. FIG. 2 shows a strip 90 of aluminum (although metals, plastics or other materials could also be used) with thirteen positions (labelled 101-112) used in the tab forming process. Each position represents one or more stamping or cutting operations required to form tab opener 10. The twelve positions and operations described below are a simplification of the actual process required to form tab opener 10, as is well known to those skilled in the art. For example the, formation of protrusions 46 may actually be a multi-step process which begins with forming relatively small dimples in strip 90 which are gradually increased in size.

Preferably, the tab openers are formed using a high-speed progressive die process, in which a single press is configured to perform many of the consecutive forming operations on successive tabs with a single downward motion. Optionally, some operations may be performed by rams or cams which move upwardly from below the strip. The strip is fed through the die and stopped at each of the positions 101-112 in order to perform the stepwise pressing and forming operations.

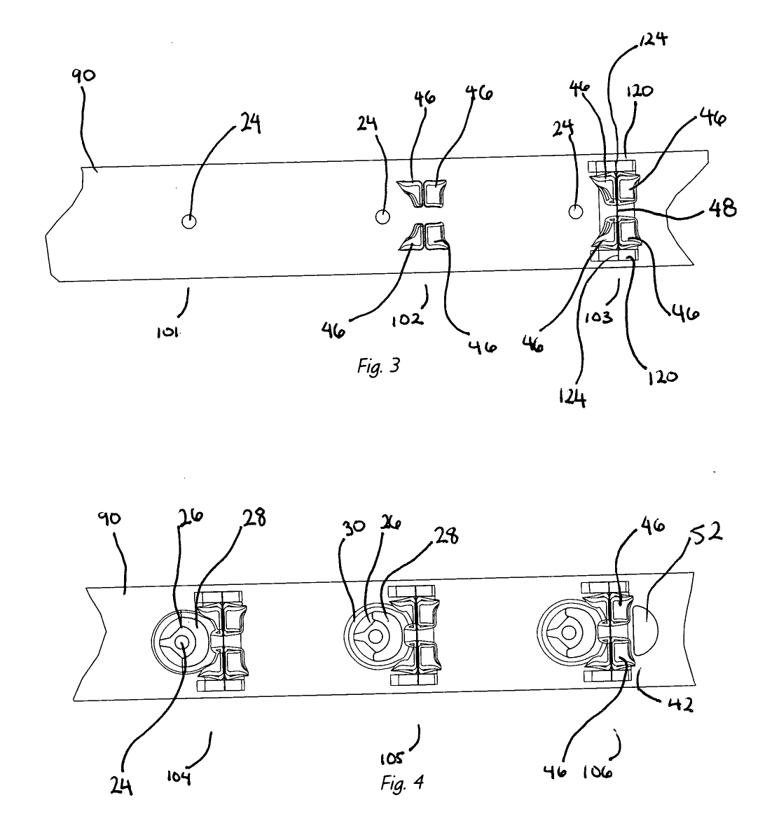

At position 101, (as shown in FIG. 3) a single press is used to cut rivet hole 24. At position 102, a press is used to form protrusions 46. The press will typically form the protrusions by stopping strip 90 over a male protrusion stamp mould (not shown). A corresponding female press section will press downwardly on strip 90 until the male protrusion mould pushes upwardly into strip 90, thus forming protrusions 46. It will be obvious to those skilled in the art that a wide variety of mechanisms could also be used to achieve the same effect. At position 103, (as shown in FIG. 3), strip 90 is cut along lines 120 along a portion of the periphery proximate to protrusions 46. The portion of the tab opener adjacent to lines 120 will be subsequently curled downwards, inwards and then upwards, as is known in the art. Each of lines 120 is divided into a front cut line and a rear cut line about joint 124. Joint 124 serves to maintain continuity in the webbing between the tab opener and the surrounding strip.

At position 104 (as shown in FIG. 4), rivet island 26 surrounding rivet aperture 24 is formed by pressing the webbing surrounding rivet island 26 downwardly using corresponding male and female press sections. In addition, curvilinear aperture 28 is also cut around the rear portion of rivet island 26. At position 105, rivet island 26 is pressed even further downwardly resulting in the delineation of sloping walls 30. At position 106, finger hole 52 is cut in rear lever portion 42 rearwardly of protrusions 46.

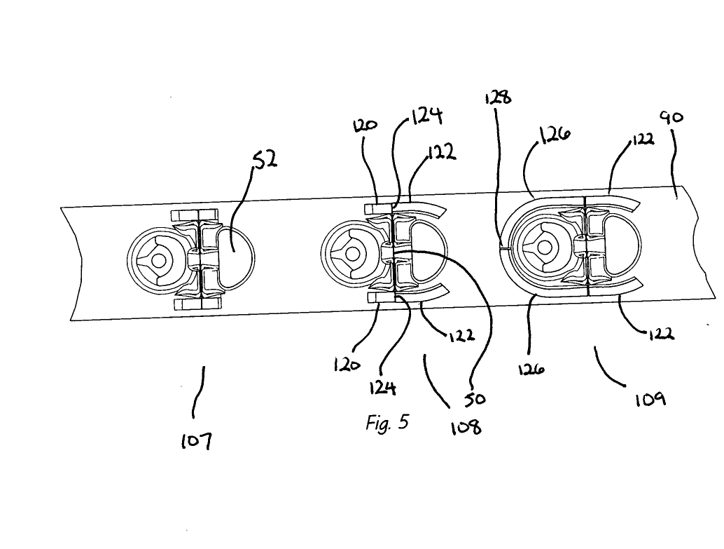

At position 107, (as shown in FIG. 5), the periphery of finger hole 52 is pressed downward, resulting in a downwardly slope edge in the finger hole. At position 108, second peripheral cuts are made along lines 122. These cuts extend rearwardly of the rear cut line made along lines 120 and define the sides of rear lever portion. At position 109, additional peripheral cuts are made along lines 126 which extend forwardly of lines 120 to meet at a joint 128 at the front tip of nose portion 20.

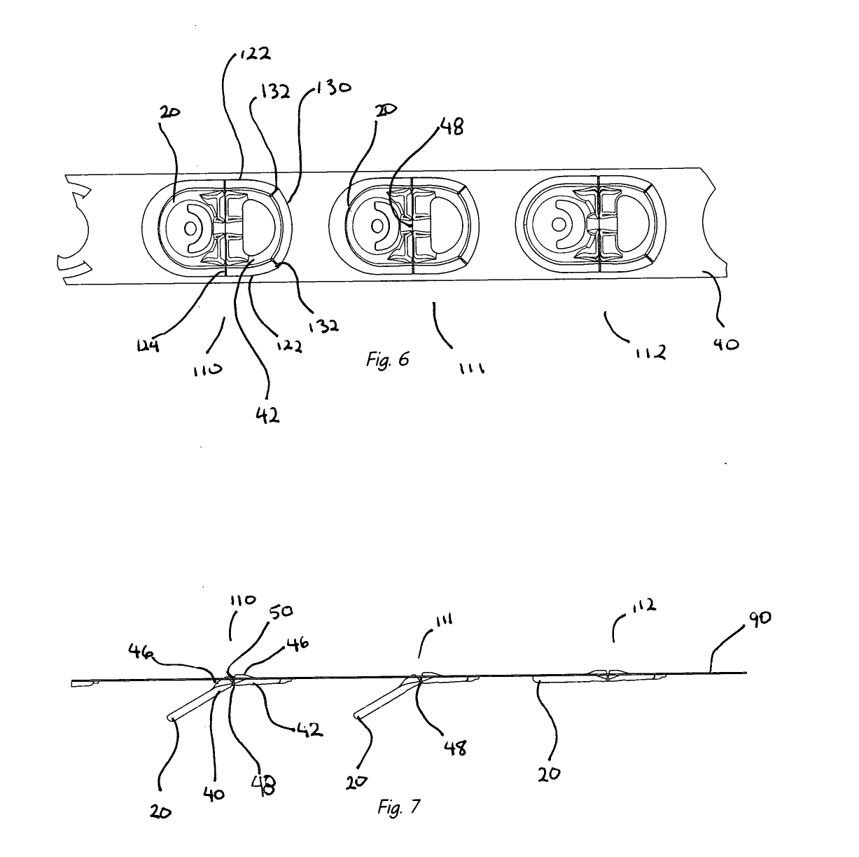

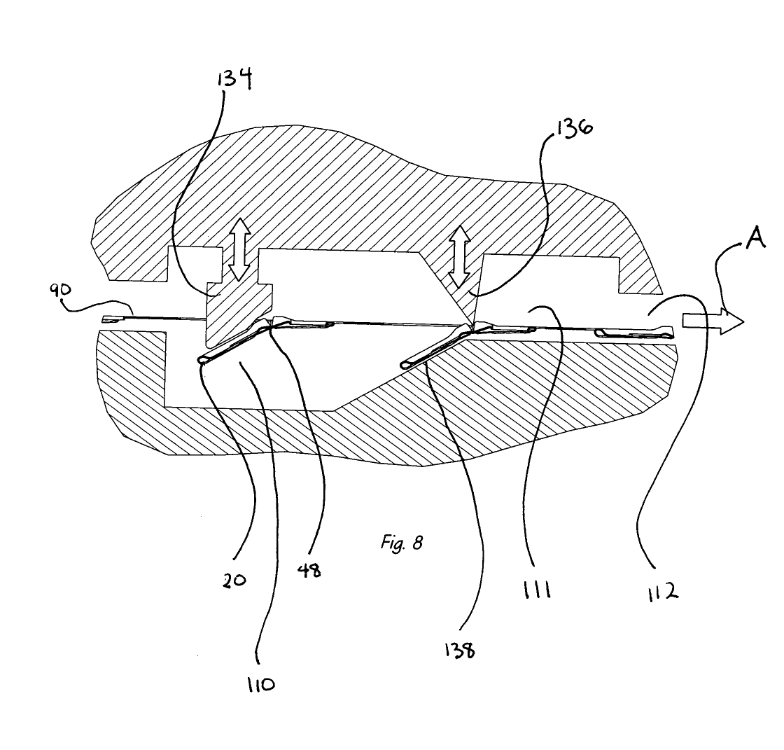

At position 110 (as shown in FIG. 6), the final peripheral cuts are made along lines 130 between the rearmost ends of lines 122. Joints 132 remain between lines 122 and lines 130. At this stage, tab opener 10 is connected to strip 90 only along joints 124 and 132. Lines 120, 122, 126, and 130 thus define a tab periphery. In addition, at position 110, as shown in FIGS. 6, 7 and 8, nose portion 20 is pushed downwardly by a press member 134, causing joint 128 to break. (Optionally, joint 128 may be cut beforehand by a separate operation.) Joints 124 and 132 maintain rear lever portion 42 in the same plane as strip 90. The downward motion of nose portion 20 may be enough to cause metal deformation of the webbing along crease line 48. At position 111 as shown in FIGS. 7 and 8, a creasing element or cutting or stamping implement 136 is pressed into crease line 48 to substantially reduce the thickness of the aluminum webbing along that line. As a result, crease line 48 can act as a hinge connecting front lever portion 40 and rear lever portion 42. The reduction in thickness will allow users to more easily lift rear lever portion 42 from the top of a can.

After the cutting operation in position 111, as shown in FIGS. 7 and 8, nose portion 20 is pushed upwardly, back to its previous position in substantially the same plane as strip 90. Preferable, an upwardly sloping surface 138 is positioned below the bent portion of tab opener 10. As the strip is moved through the progressive die in the direction of arrow A, nose portion 20 abuts surface 138, it will be raised to lie in the same plane as strip 90 at position 112 (Optionally, the bent portion of tab opener 10 is pushed back to its previous position with a cam or spring activated mechanism located below the strip).

After passing through the above-described steps, tab opener 10 may have additional steps performed or may be completely severed from strip 90, and is ready to be riveted to a can top.

Strip 90, as shown, only accommodates a single row of tab openers. However, multiple rows may be used, either in parallel or in a staggered formation.

The astute observer will note that crease line 48 first appears in position 103 in FIG. 3. As previously discussed, the formation of protrusions 48 may occur over a number of pressing operations. In the initial pressing operations for the formation of protrusions 48, a first creasing element may be employed to make an initial crease along crease line 48. This creasing element may be relatively blunt as compared to creasing element 136. The initial, and shallower, formation of crease line 148 is possible given that protrusions 146 do not extend high enough in the initial stages to block formation of the crease line. In addition, the first crease line also assists in the bending of tab opener 10 at position 110.

It will be obvious to those skilled in the art that the order of the actions performed on the tab may be rearranged to suit the needs of the manufacturer. For example, while lines 122 and 130 are cut prior to bending the nose section downwards, the cuts may be made after the bending operation.

It will also be clear to those skilled in the art that a number of possible and/or desirable edge curling operations are not described in detail. Aluminum edges can be very sharp and may cut a user's finger. As a result, many of the exposed edges may be subjected to curling operations to curl the edges underneath the tap opener.

It will be obvious to those skilled in the art that the techniques and processes described herein could be applied to other workpieces of a variety of sizes. Essentially, any workpiece having a crease line that separates a first section from a second section, where the crease line is less accessible for normal cutting or stamping operation because the crease line lies adjacent to a protrusion, can be formed using the bending technique described above.

Other modifications and alterations may be used in the design and manufacture of the apparatus and process of the present invention without departing from the spirit and scope of the accompanying claims.

Throughout this specification and the claims which follow, unless the context requires otherwise, the word “comprise” and variations such as “comprises” or “comprising”, will be understood to imply the inclusion of a stated integer or step or group of integers or steps but not to the exclusion of any other integer or step or group of integers or steps.

1. A method of making a stamped workpiece from a base material sheet, said base material sheet having a thickness and defining a first plane, the stamped workpiece having a protrusion and a crease line substantially adjacent thereto, the crease line dividing the stamped workpiece into a first section and a second section, the method comprising the steps of:
a) providing at least one protrusion in said base material sheet;
b) defining a workpiece periphery in said base material sheet, said periphery bounding an area of said base material sheet, said area having a first section and a second section;
c) substantially separating said workpiece periphery adjacent to said first section from the remainder of said base material sheet;
d) bending the first section away from said first plane along a crease line;
e) substantially reducing the thickness of the base material sheet along the crease line; and
f) detaching the workpiece from said base material sheet along said workpiece periphery.

2. A method as claimed in claim 1, wherein said at least one protrusion comprises a first protrusion and a second protrusion.

3. A method as claimed in claim 2, wherein said first protrusion is opposed to said second protrusion.

4. A method as claimed in claim 3, wherein said first protrusion is positioned within said first section and said second protrusion is positioned within said second section.

5. A method as claimed in claim 4, wherein said first protrusion and said second protrusion are each provided with an abutment face, said first and second protrusions being positioned such that said abutment faces are opposed one to the other.

6. A method as claimed in claim 1, further comprising the additional step of bending said first section back towards said first plane, such that said first section lies substantially coplanar with said second section.

7. A method for forming pull tabs for containers from a base material sheet, said base material sheet having a thickness and defining a first plane, the pull tab having a protrusion and a crease line substantially adjacent thereto, the crease line dividing the stamped pull tab into a first section and a second section, the method comprising the steps of:
a) providing at least one protrusion in said base material sheet;
b) defining a tab periphery in said base material sheet, said tab periphery bounding an area of said base material sheet, said area having a first section and a second section;
c) substantially separating said tab periphery adjacent the first section from the remainder of said base material sheet;
d) bending the first section away from said first plane along a crease line; and
e) substantially reducing the thickness of the base material sheet along the crease line.

8. A method as claimed in claim 7, wherein said at least one protrusion comprises a first protrusion and a second protrusion.

9. A method as claimed in claim 8, wherein said first protrusion is opposed to said second protrusion.

10. A method as claimed in claim 9, wherein said first protrusion lies within said first section and said second protrusion lies within said second section.

11. A method as claimed in claim 10, wherein said first protrusion and said second protrusion are each provided with an abutment face, said first and second protrusions are positioned such that said abutment faces are opposed to one another.

12. A method as claimed in claim 7, further comprising the additional step of bending said first section back towards said first plane, such that said first section lies substantially coplanar with said second section.

13. A method as claimed in claim 7, wherein said first section is bent downwardly sufficiently to cause material deformation along said crease line.

14. A method as claimed in claim 7, wherein said base material sheet is an elongated strip.

15. A method as claimed in claim 14, wherein said steps (a) through (e) are performed concurrently in a progressive die for sequential pull-tabs.

16. A method as claimed in claim 15, wherein said strip has a width sufficient to accommodate the formation of at least two pull tabs positioned parallel to one another, and wherein each of said steps is performed concurrently for each of said at least two pull tabs positioned parallel to one another.

17. A method as claimed in claim 7, further comprising the step of detaching the pull tab from said base material sheet along said tab periphery.
